(19) United States
(12) Patent Application Publication
(10) Pub. No.: US 2009/0075706 A1
(43) Pub. Date: Mar. 19, 2009

(54) HOUSING ASSEMBLY FOR PORTABLE ELECTRONIC DEVICE

(75) Inventor: CHENG-YI CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,843

(22) Filed: Dec. 27, 2007

(30) Foreign Application Priority Data
Sep. 17, 2007 (CN) 200710201744.X

(51) Int. Cl. H04M 1/00; G06F 1/16

(52) U.S. Cl. 455/575.3

(57) ABSTRACT

A housing assembly (22) for use in a portable electronic device (20) includes an upper shell (242), a keypad board (244) located under the upper shell, a circuit board (246) located under the keypad board, and a lower shell (248) accommodating the circuit board. The upper shell includes a supporting board (2422) and a mounting frame (2424) located around the supporting board. The supporting board is made of metal and defining through holes (2423) therethrough. The mounting frame is made of plastic, and the mounting frame and the supporting board are integratedly formed in injection molding. The keypad board has keys (2442) formed thereon respectively corresponding to the through holes. The circuit board has switch points (2466) formed thereon respectively corresponding to the keys. The keypad board and the circuit board are mounted between the lower shell and the upper shell.

### BACKGROUND OF THE INVENTION

1. Field of the Invention

The present invention generally relates to housing assemblies, and particularly to a housing assembly of a portable electronic device, such as a mobile telephone.

2. Description of Related Art

With the development of wireless communication and information processing technologies, portable electronic devices, such as mobile telephones and electronic notebooks, are now in widespread use. These portable electronic devices enable consumers to enjoy high technology services, almost anytime and anywhere. The developing trend of these portable electronic devices is to be light, thin, short, and small in volume.

A typical housing assembly of a portable electronic device includes an upper shell, a keypad module located in the upper shell, a circuit board positioned under the keypad module, and a lower shell accommodating the circuit board. The upper shell defines a hole in a main body portion. The keypad module includes a supporting board and a keypad board fixed to the supporting board. The supporting board defines a plurality of through holes therein. The keypad board has a plurality of keys formed thereon respectively corresponding to the plurality of through holes. The circuit board has a plurality of switch points formed thereon respectively corresponding to the plurality of keys.

After assembled, the keypad board is attached to the supporting board and each of the keys is exposed through a corresponding through hole of the supporting board. The keypad module is fixed to the upper shell and the supporting board is exposed through the hole of the upper shell. The circuit board is placed in the lower shell. The upper shell is fixed on the lower shell and each switch point corresponds to a corresponding key. The key is pressed downward so as to make contact with a corresponding switch point, thereby generating an input signal. However, such a housing assembly has a relatively large volume. In addition, the upper shell is typically made of plastic and is liable to be damaged when it has light and thin volume.

Therefore, a new housing assembly is desired in order to overcome the above-described problems.

### SUMMARY

In one aspect thereof, a housing assembly for a portable electronic device includes an upper shell. The upper shell includes a supporting board and a mounting frame located around the supporting board. The supporting board is made of metal and the mounting frame is made of plastic. The mounting frame and the supporting board are integratedly formed in injection molding.

Other advantages and novel features of the embodiments will become more apparent from the following detailed description thereof, when taken in conjunction with the accompanying drawings.

### BRIEF DESCRIPTION OF THE DRAWINGS

Many aspects of the present housing assembly can be better understood with reference to the following drawings. The components in the drawings are not necessarily drawn to scale, the emphasis instead being placed upon clearly illustrating the principles of the present housing assembly and its potential applications. Moreover, in the drawings, like reference numerals designate corresponding parts throughout the several views.

FIG. 1 is an exploded, isometric view of a portable electronic device, in accordance with a present embodiment.

FIG. 2 is a partially assembled, isometric view of the portable electronic device shown in FIG. 1.

FIG. 3 is an assembled, isometric view of the portable electronic device shown in FIG. 2.

### DETAILED DESCRIPTION OF THE EMBODIMENTS

The present housing assembly is suitable for portable electronic devices, such as mobile phones, PDAs (personal digital assistants), and the like. Other applications with similar housing employed can also be found.

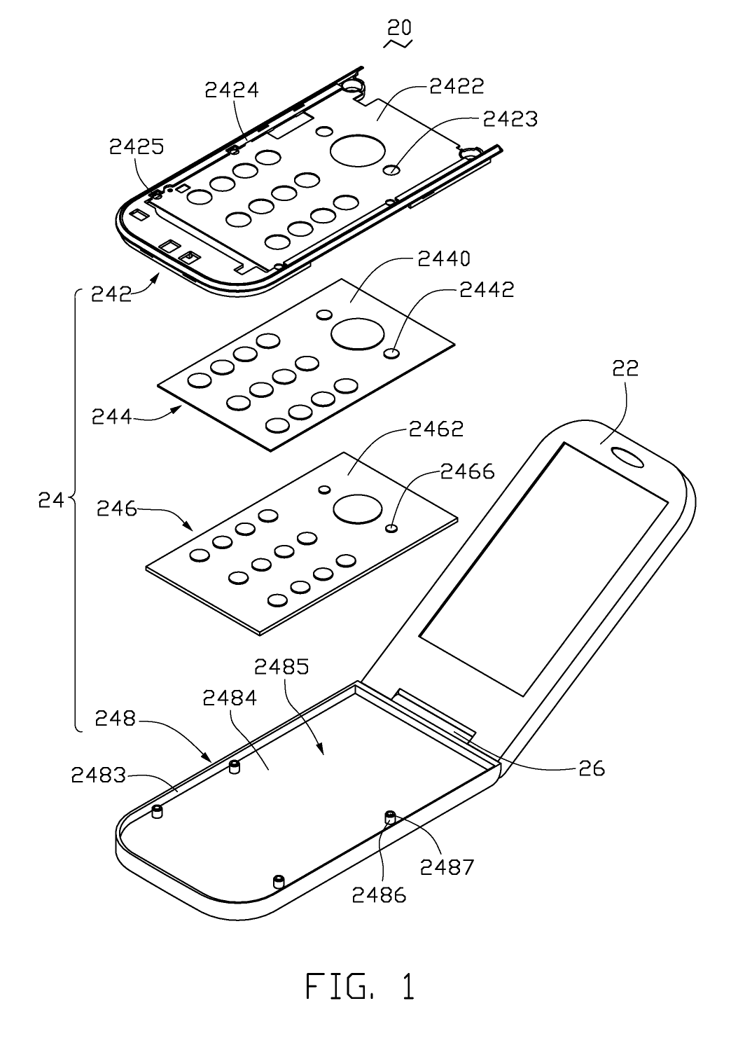

Referring to the drawings in detail, FIG. 1 shows a portable electronic device 20 employing the present housing assembly 24. The portable electronic device 20 includes a cover 22 and a hinge mechanism 26 interconnecting the cover 22 to the housing assembly 24.

The housing assembly 24 includes an upper shell 242, a keypad board 244 located under the upper shell 242, a circuit board 246 located under the keypad board 244, and a lower shell 248 for accommodating the circuit board 246. The upper shell 242 is fixed to the lower shell 248 thereby assembling the housing assembly 24.

The upper shell 242 includes a supporting board 2422 and a mounting frame 2424 located around three edges of the supporting board 2422. The supporting board 2422 is a substantially rectangular flat board and defines a plurality of through holes 2423 therethrough. The supporting board 2422 is made of metal. The mounting frame 2424 is made of plastic and defines a plurality of mounting holes 2425 therethrough. The mounting frame 2424 and the supporting board 2422 are integratedly formed in injection molding.

The keypad board 244 is a substantially rectangular flat board. The size of the keypad board 244 is substantially the same as that of the supporting board 2422. The keypad board 244 has a top surface 2440 and a plurality of keys 2442 formed on the top surface 2440. Each key 2442 is configured (i.e., structured and arranged) for corresponding with a through hole 2423 of the supporting board 2422.

The circuit board 246 is a substantially rectangular flat board and has a mounting surface 2462 and a plurality of switch points 2466 formed on the mounting surface 2462. Each switch point 2466 is configured for corresponding with a key 2442 of the keypad board 244. The size of the circuit board 246 is substantially the same as that of the keypad board 244.

The lower shell 248 is a substantially rectangular block, and has a main body portion 2484 and a sidewall 2483 extending upwardly from four edges of the main body portion 2484. The main body portion 2484 cooperates with the sidewall 2483 to define a receiving cavity 2485 configured for receiving the circuit board 246 therein. A plurality of mounting pins 2486 are formed on the main body portion 2484, located in the receiving cavity 2485 and adjacent to the sidewall 2483. Each mounting pin 2486 defines a threaded pin hole 2487 therein and cooperates with a corresponding mounting hole 2425 of the upper shell 242 to fix the upper shell 242 to the lower shell 248 by a bolt (not shown).

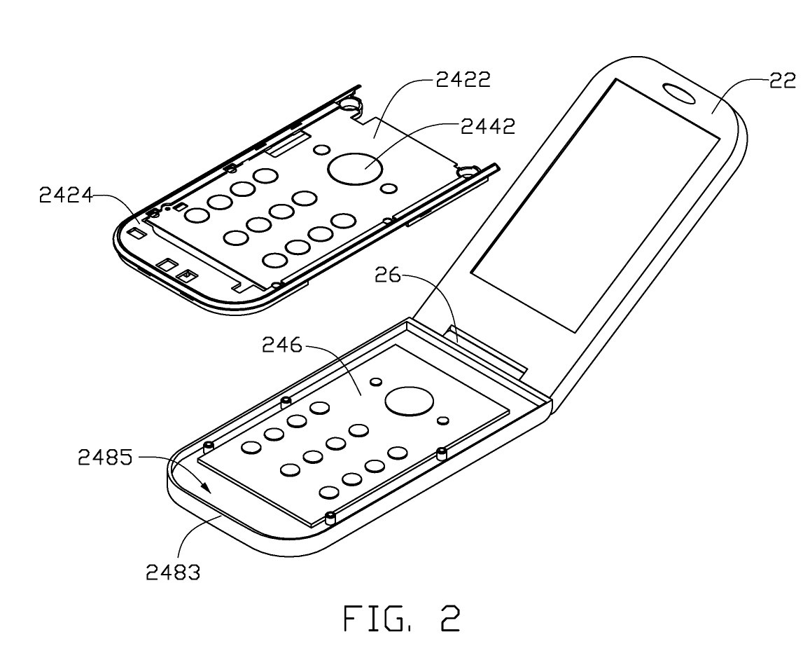

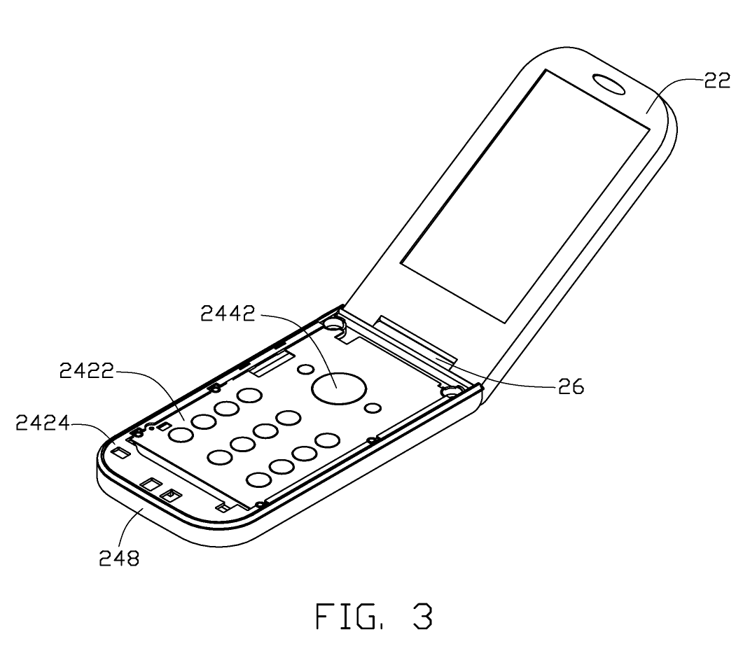

Also referring to FIGS. 2-3, after the housing assembly 24 is assembled, the keypad board 244 is fixed to the supporting board 2422 by glue. Each key 2442 is received in a corresponding through hole 2423 with one end of the key 2442 exposing out from the through hole 2423. The keypad board 244, the upper shell 242, and the circuit board 246 are received in the receiving cavity 2485 of the lower shell 248 with each mounting pin 2486 traveling through a corresponding mounting hole 2425 of the upper shell 242 and each bolt being bolted in a corresponding pin hole 2487. The keypad board 244 is located on the mounting surface 2462 of the circuit board 246. Each switch point 2466 corresponds to a key 2442 of the keypad board 244. In use, the key 2442 is pressed downward so as to make contact with a corresponding switch point 2466, thereby generating an input signal.

It should be understood that the supporting board 2422 may be electrically connected with a ground of the circuit board 246 for grounding the static electricity of the upper shell 242, thereby protecting electronic components on the circuit board 246 from being damaged by the static electricity.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing assembly for portable electronic device, comprising an upper shell, the upper shell having a supporting board and a mounting frame located around the supporting board, the supporting board being made of metal, the mounting frame being made of plastic, and the mounting frame and the supporting board being integrally formed in injection molding.

2. The housing assembly as claimed in claim 1, further comprising a lower shell fixed to the upper shell.

3. The housing assembly as claimed in claim 2, wherein the lower shell has a plurality of mounting pins, the upper shell defining therein a plurality of mounting holes configured for receiving the plurality of mounting pins.

4. The housing assembly as claimed in claim 1, further comprising a keypad board having a plurality of keys formed at a top surface thereof, the supporting board defining a plurality of through holes therethrough, and each through hole corresponding to a key.

5. The housing assembly as claimed in claim 4, further comprising a circuit board having a plurality of switch points formed thereon, each switch point corresponding to a key.

6. The housing assembly as claimed in claim 4, wherein the keypad board is mounted to the upper shell with the supporting board located on the top surface of the keypad board.

7. The housing assembly as claimed in claim 4, wherein the supporting board is electrically connected with a ground of the circuit board for grounding the static electricity of the upper shell.

8. A housing assembly for portable electronic device, comprising:
an upper shell, the upper shell having a supporting board and a mounting frame located around the supporting board, the supporting board being made of metal and defining a plurality of through holes therethrough, the mounting frame being made of plastic, and the mounting frame and the supporting board being integratedly formed in injection molding;
a keypad board attached to the upper shell, the keypad board having a plurality of keys formed thereon, each key corresponding to a through hole;
a circuit board located under the keypad board, the circuit board having a plurality of switch points formed thereon, each switch point corresponding to the a key; and
a lower shell, the circuit board and the keypad board being fixed between the upper shell and the lower shell.

9. The housing assembly as claimed in claim 8, wherein the lower shell has a plurality of mounting pins formed thereon, the upper shell defining a plurality of mounting holes therethrough, each mounting hole being configured for receiving a corresponding mounting pin.

10. The housing assembly as claimed in claim 8, wherein the supporting board is electrically connected with a ground of the circuit board for grounding the static electricity of the upper shell.

11. The housing assembly as claimed in claim 8, wherein the lower shell is a substantially rectangular block and defines a receiving cavity therein configured for receiving the circuit board.
